(19) United States
(12) Patent Application Publication
(10) Pub. No.: US 2008/0060665 A1
(43) Pub. Date: Mar. 13, 2008

(54) Coater for Hair and Cosmetic Paint Container with the Coater

(75) Inventors: Takashi Umeno, Gunma (JP); Toshihiro Takahashi, Gunma (JP)

Correspondence Address: BUCHANAN, INGERSOLL & ROONEY PC, POST OFFICE BOX 1404, ALEXANDRIA, VA, 22313-1404, US

(73) Assignee: Mitsubishi Pencil Co., Ltd., Shinagawa-ku (JP)

(21) Appl. No.: 11/597,527

(22) PCT Filed: May 26, 2005
(86) PCT No.: PCT/JP05/09659

§ 371 Date: Nov. 27, 2006

(30) Foreign Application Priority Data
Jun. 4, 2004 (JP) 2004-167320

(51) Int. Cl. A45D 24/22; A46B 11/00; B43K 5/00

(52) U.S. Cl. 132/112; 401/196; 401/28

(57) ABSTRACT

The present invention is a hair coater which appropriately delivers an paint liquid without liquid leakage of the paint liquid, and which, in addition, can assure sufficient paint performance, preventing the paint liquid or the like from being directly applied to the scalp, and the hair coater, which while combing hair by a comber made up of comb members and a multiple number of porous coating elements arranged comb-like in a row along the comb members, is able to apply the paint liquid in a container being attached to the hair by means of the porous coating elements, and is characterized in that the paint liquid retention force of the porous coating elements falls within a range of 120 to 250 mm. The present invention also includes a coater-equipped cosmetic container with the aforementioned hair coater.

### TECHNICAL FIELD

The present invention relates to a hair-care coater (coater for hair) and a cosmetic paint container with the coater, and relates to a hair-care coater which is attached to a container body to apply an coater liquid (hair dye, hair liquid, hair tonic etc.) stored in the container while combing hair (including hairs of humans and others such as pet animals, etc.) as well as to a cosmetic paint container with that coater.

### BACKGROUND ART

Conventionally there have been known cosmetic paint containers equipped with a hair coater which leads a hair dye or the like stored in a container to the spaces between comb teeth of a comber attached to the container to dye hair while combing hair with the comber.

As an example, a configuration has been proposed which is composed of a medical fluid storage container serving as a handle and a comber joined to the container, wherein the comber is composed of a hollow shaft and a plurality of hollow comb teeth joined to the shaft, and the comb teeth are projectively formed so that non-ejecting comb teeth and ejecting comb teeth are arranged alternately (see patent document 1). The non-ejecting comb teeth and ejecting comb teeth each are formed in an approximately triangular plate-like configuration so that the width becomes narrower as it goes toward its top, and the ejecting comb teeth are each formed with an ejection through hole from which medical fluid is ejected. The distance from the tip of the ejecting comb tooth to the ejection hole is specified to fall within a range of 5 to 60% of the length from the tip of the ejection comb tooth to the proximal end (shaft) while the interval between ejecting comb teeth is specified to fall within a range of 4 to 8 mm. This specification makes optimal the amount of medical fluid held between comb teeth and makes paint of medical fluid over hair easy and uniform.

As another configuration a comb-equipped paint container has been proposed which is a container having a hollow handle portion attached to a container body and serving as a fluid guiding passage and a comber having a large number of hollow comb teeth arranged longitudinally, wherein each tooth has a fluid ejection path connected to the guiding passage of the handle portion and extended along the tooth length and ejection holes that are connected to the front end of the ejection path and penetrate through the comb tooth from the front to rear (see patent document 2, for example). The ejection holes are arranged so that their positions are shifted between adjacent comb teeth with respect to the tooth length direction. With this configuration, it is possible to apply the fluid over hair from the vicinity of hair roots to hair tips without unevenness, thus facilitating fluid paint work.

There is another proposal of a comb-equipped cap to be attached to a brim of a container body, in which a row of main comb teeth is provided, the main comb teeth being formed with ejection holes that open on the side faces thereof and are connected to the container interior. Further, the comb-equipped cap also has sub comb teeth (without holes) which are arranged on both sides along the main comb-teeth with their tips as high as or higher than those of the main comb teeth (see patent document 3, for example).

With this configuration, the user is able to perform combing while keeping the comber or comb body approximately perpendicular to the scalp. It is also possible to prevent color unevenness due to change of the angle of the comb body when combing hair, especially prevent color unevenness at the areas close to hair roots.

However, these hair paint cosmetic containers entail the occurrence of excessive liquid leakage from the injection opening to the comb body or holes. Further, uniform liquid supply from the communication passage or handle passage cannot be done, causing unevenness in hair dying. To deal with this, there has been a proposal of a hair coater in which an paint liquid is absorbed in a reservoir support that is provided in a container and paint pen cores presenting capillarity arranged in rows are used as a comber (see patent documents 4 and 5, for example). Since the comb teeth of the comber have no ejection holes and openings as described above, no channeling at the paths between teeth will occur. Accordingly, this structure with pen type paint cores allows the fluid to be uniformly supplied to every comb tooth or every paint core, hence no unevenness or other defect will occur in hair dying.

However, with the above conventional hair coater, paint liquid cannot be supplied well to hair or excessive liquid leakage (forward leakage) may occur depending on the paint liquid. In some cases the paint liquid from the container cannot be sufficiently supplied to the tips of the paint pen cores, and in other cases, the paint liquid from paint pen cores may directly touch the scalp etc. Accordingly, there has been a risk of the scalp being hurt when used for a hair dye. Further, when the comber has a conventional configuration, it is impossible to secure sufficient paint performance to hair. Further, shed hairs etc. adhere to the comb member, and it is impossible to easily remove shed hairs etc., from the comb member or perform other maintenance. As a result there have been inconvenient cases where the coater still having paint liquid left in the container is discarded.

[Patent Document 1]
Japanese Patent Paint Laid-open 2003-019023

[Patent Document 2]
Japanese Patent Paint Laid-open 2002-159325

[Patent Document 3]
Japanese Patent Paint Laid-open 2002-191427

[Patent Document 4]
Japanese Utility Model Paint Laid-open Hei-4-60116

[Patent Document 5]
Japanese Utility Model Paint Laid-open Hei-4-60117

### DISCLOSURE OF THE INVENTION

### Problems to be Solved by the Invention

In view of the above circumstances it is therefore an object of the present invention to provide a hair coater which appropriately delivers an paint liquid without liquid leakage of the paint liquid, and provide a hair coater which, in addition to the aforementioned feature, can assure sufficient paint performance, preventing the paint liquid or the like from being directly applied to the scalp as well as to provide an coater-equipped cosmetic container having the same hair coater.

### Means for Solving the Problems

The present inventors hereof have found that in the comber structure of a hair coater, use of a porous coating body is more excellent than direct provision of feed openings or ejection openings for comb teeth themselves, that when such a porous coating body is used, a comb member (a normal comb) arranged along with it is supplementally needed, and that in order to prevent liquid leakage (forward leakage) of the paint liquid and supply the paint liquid to the comber appropriately, the porous coating body should have an paint liquid retention force for the paint liquid being used, ranging from 120 to 250 mm, particularly 250 to 205 mm, and have completed the present invention.

Further, the present inventors hereof have found that when the aforementioned comb member is provided supplementally, the tips of comb teeth of the comb member are adapted to stick further out from the front end of the porous coating body by the range of 0.2 to 3.0 mm, whereby it is possible to avoid the paint liquid from the paint body being directly applied to and dirtying the scalp and apply the hairline from, essentially, the hair roots so as to make the unpainted place along the hairline unrecognizable. They have also found that it is possible to apply the paint liquid uniformly over substantially all parts of the hair without dirtying the comb member with the liquid, by arranging the comb member and porous coating body closely so that they are kept out of contact from each other with a spacing of 5.0 mm or lower, and are particularly with a spacing falling within the range of 3.5 to 1.0 mm, and have completed the present invention.

That is, the comb coater of the present invention and coater-equipped cosmetic container are characterized by the following configurations and means described in (1) to (7).
(1). A hair care coater which, while combing hair by a comber made up of a porous coating body and a comb member arranged parallel to the porous coating body, is able to apply an paint liquid in a container being attached to the hair by means of the porous coating body, wherein the paint liquid retention (holding) force of the porous coating body falls within a range of 120 to 250 mm.

In addition, the paint liquid retention force herein is the value based on the following method of measurement. (The method of measurement of retention force)

As shown in FIGS. 6(a) and 6(b), one end of a silicone tube 91 is put in a storage container 90 with an paint liquid while the other end is coupled to an object under test 92 (porous coating body) and the tube is filled with the paint liquid. At this point of time, the interior of the object under test is filled up to its top end with the paint liquid. Then, the lower end of the object under test is lifted gradually. At this point, a meniscus is formed at the top end of the object under test so as to retain a liquid column of the paint liquid by the capillary force of the object under test. The distance (X) between the lower end of the object under test and the liquid surface is the liquid column height of the paint liquid supported by the object under test. As the liquid column of the paint liquid retained by the object under test is made higher, the object under test cannot retain the liquid column of the paint liquid any longer and the height when air enters from the bottom of the object under test is determined to thereby measure the “retention force”. Strictly speaking, the retention force is defined as (height X(mm))×(paint liquid density (ρ))×(gravity (g)), but the density (β) and the gravity (g) are constant, so the invention uses the height (X) as the retention force.
(2). The hair care coater written in the above (1), wherein the distal ends of comb teeth of the comb member stick further out by a distance ranging from 0.2 to 3.0 mm from the front end of the porous coating body.
(3). The hair coater written in the above (1) or (2), wherein the porous coating body and the comb tooth of the comb member are kept out of contact with each other and arranged close to each other with a spacing of 5.0 mm or lower.
(4). The hair care coater written in the above (1) or (2), wherein the comb tooth of the comb member is formed of resin or metal while the porous coating body is formed of one or more selected from a sliver pen core, felt-like material or continuous-foamed sponge-like material.
(5). The hair care coater written in any of the above (1) or (2), wherein the porous coating body is formed of a plurality of pen type porous coating elements arranged in a comb-like pattern.
(6). An coater-equipped cosmetic container comprising: a container body for an paint liquid; and a hair care coater attached to the container body, the hair care coater which, while combing hair by a comber made up of a porous coating body and a comb member arranged parallel to the porous coating body, is able to apply an paint liquid in a container being attached to the hair by means of the porous coating body, wherein the paint liquid retention force of the porous coating body falls within a range of 120 to 250 mm.
(7). The coater-equipped cosmetic container written in the above (6), wherein a reservoir support of the paint liquid is accommodated inside the container and the reservoir support comprises padding.

### EFFECT OF THE INVENTION

According to the thus constructed configuration or means of the present invention, when the porous coating body, examples of paint bodies including sliver pen cores, felt-like materials, continuous-foamed sponge-like materials, etc., is adapted to have an paint retention force ranging from 120 to 250 mm, it is possible to prevent liquid leakage (forward leakage) of the paint liquid and provide a suitable supply of the paint liquid to the comber. Since the tips of the comb member stick further out by 0.2 to 3.0 mm from the front end of the porous coating body of the comber, it is possible to secure sufficient paint performance as well as to avoid dirtying the scalp because the paint liquid from the paint body will not be directly applied to the scalp. Further, provision of the porous coating body and comb teeth of the comb member arranged closely in parallel and kept out of contact with each other with a spacing of 5 mm or shorter, enables uniform paint to essentially all parts of hair without dirtying the comb member with the paint liquid.

### BRIEF DESCRIPTION OF THE DRAWINGS

FIG. 1 is a perspective view showing a coater-equipped cosmetic container having a hair coater according to the present invention with its cap removed.

FIGS. 2(a) and 2(b) are front partial sectional view and side sectional view of a coater-equipped cosmetic container according to the present invention.

FIG. 3 is an exploded perspective view showing a coater-equipped cosmetic container according to the present invention.

FIGS. 4(a) and 4(b) are front view and side view of a comb member used for a hair coater according to the present invention.

FIG. 5 is a perspective view showing another embodiment of a coater-equipped cosmetic container according to the present invention.

FIGS. 6(a) and 6(b) are overall views showing a device for measuring liquid retaining force as an indicator when a porous material retains a liquid such as paint liquid etc.

### DESCRIPTION OF REFERENCE NUMERALS

1 coater-equipped cosmetic container
2 container body
4 reservoir support
5A, 5B lid member
10 porous coating body
11 comb member
12 binding member
14 comb teeth
15 cap

### BEST MODE FOR CARRYING OUT THE INVENTION

Referring next to the drawings a hair coater of the present invention and a cosmetic paint container with the coater will be described in detail based on the best mode of the present invention. However, the hair coater of the present invention and the coater-equipped cosmetic container should not be limited to the following embodiment.

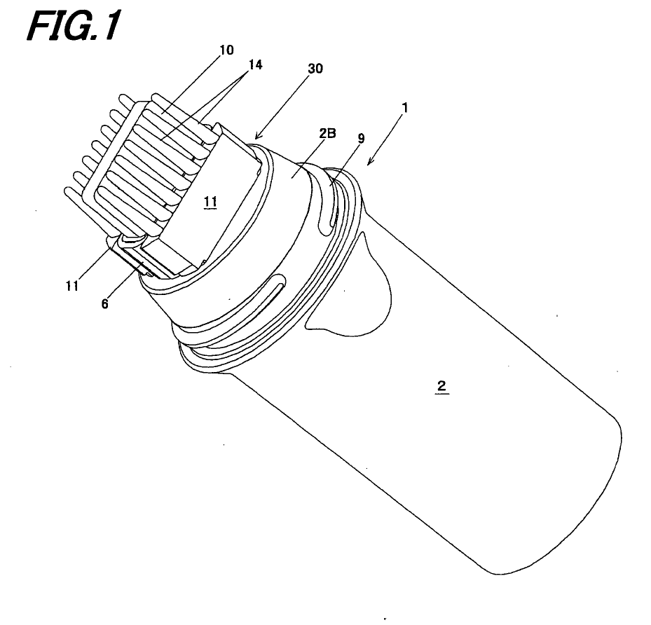

As shown in FIGS. 1 to 3 the hair care coater of an coater-equipped cosmetic container 1 of the present embodiment, specifically, a comber 30 is composed of comb members 11 and a plate-shaped porous coating body 10 arranged with the comb members 11, and is constructed such that an paint fluid in a container body 2 can be applied over hair by way of paint body 10 as hair is combed with comber 30.

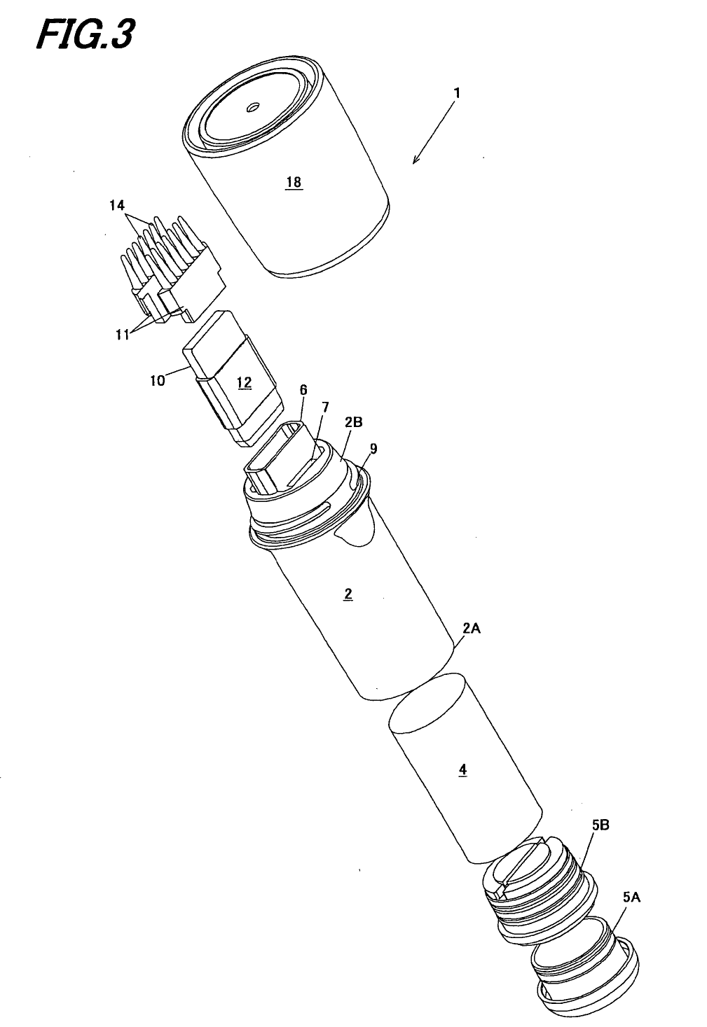

As shown in FIGS. 1 to 3, in cosmetic container 1 resin container body 2 is formed in a cylindrical shape. A rear end 2A of container body 2 is made open so that a reservoir support member 4 shown in FIG. 3 can be inserted and stored into container body 2. Support member 4 supports a paint fluid or cosmetic substance. The inner wall at rear end 2A is formed with a thread while a lid member 5B is also formed with a thread so that the two are screw fitted to each other to seal off the opening and lid member 5B is fixed pressing the rear end 4B of support member 4. Further, in lid member 5B, a lid member 5A for design purposes is attached to lid member 5B.

As the aforementioned reservoir support member 4, the material should not be particularly limited as long as it can support the coater liquid. For example, padding etc., can be considered.

At the front end 2B of container body 2, a rectangular cylindrical attachment hole 6, socket holes 7 and a threaded portion 9 are formed, the attachment hole 6 being formed at the approximate center. Plate-shaped porous coating body 10 is inserted into attachment hole 6 while comb members 11 made of resin are attached to socket holes 7 arranged on both sides. Threaded portion 9 is screw fitted to a threaded portion formed on the interior wall of an aftermentioned cap. Porous coating body 10 is mounted into attachment hole 6 by means of a rectangular support member 12, so that porous coating body 10 is arranged along the axial direction of container body 2. The proximal end 10A of porous coating body 10 is inserted into part of the front end 4B of the aforementioned support member 4 and coupled when it is mounted.

Here, the exterior wall surface of rectangular support member 12 is put in fluid-tight contact with the cylindrical interior wall surface of attachment hole 6, and support member 12 may be fitted either removably to, or totally fixed to, attachment hole 6.

The aforementioned porous coating body 10 preferably has a liquid retention force (mm) of the paint liquid being used, falling within the range of 120 to 250 mm in the aforementioned measurement, more preferably falling within the range of 150 to 205 mm. Use of a porous coating body 10 having a liquid retention force falling within the above range makes it possible to prevent liquid leakage (forward leakage) of the paint liquid and provide a suitable supply of the paint liquid to comber 30. If the liquid retention force for the paint liquid exceeds the above range, it becomes difficult to prevent forward leakage. On the contrary, if it is lower than the above range, it becomes difficult to provide a suitable supply of the paint liquid from the container.

As a porous coating body material usable within the aforementioned range, sliver pen cores, felt-like materials, continuous-foamed sponge-like materials, etc., are preferable.

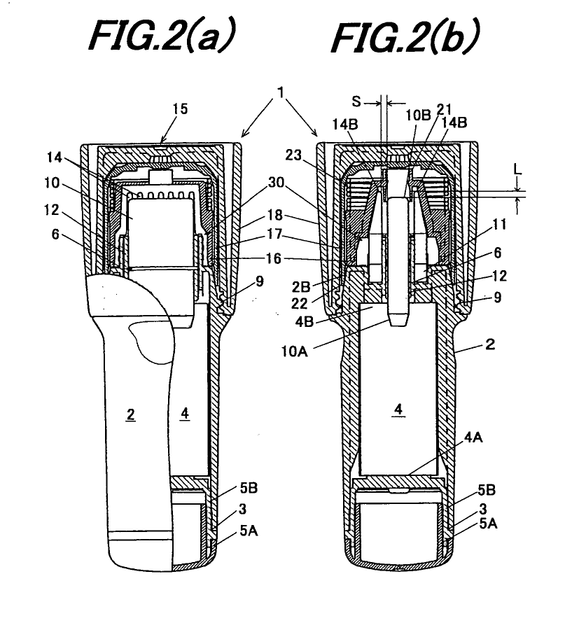

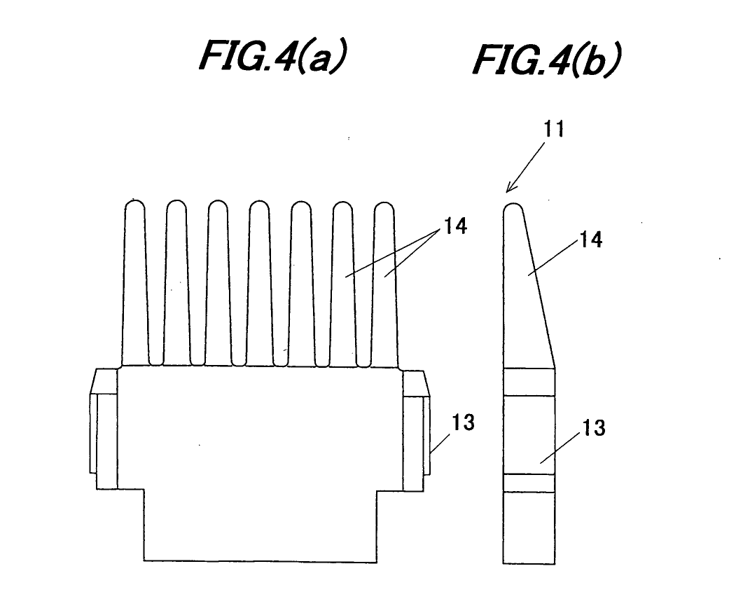

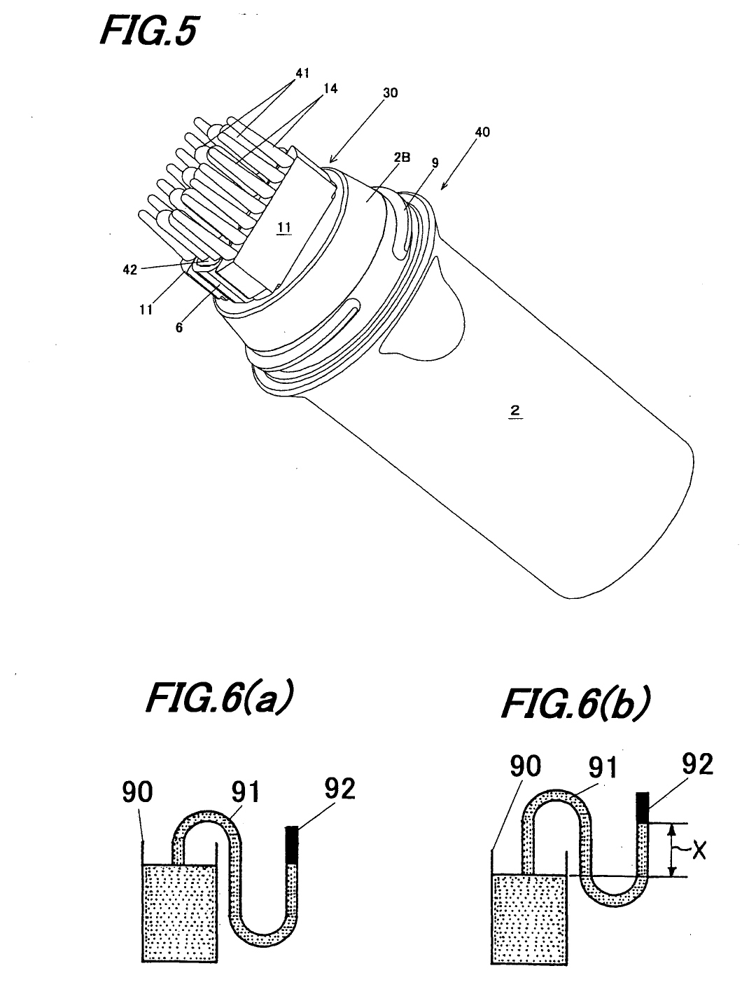

Comb member 11 is formed of a molded member of resin as shown in FIG. 4, and is constructed of a base 13 and a plurality of comb teeth 14 arranged on the front end face of base 13 at regular intervals. Base 13 is formed to be an engaging portion to be detachably engaged into the aforementioned socket hole 7. The distal part of comb tooth 14 is made round. When base 13 and socket hole 7 are engaged with each other, comb members 11 are set in parallel with porous coating body 10 mounted in attachment hole 6. In this attached state of comb members 11, the distal end 14B of comb teeth 14 stick further out from distal end 10B of porous coating body 10. The amount of projection (L) as shown in FIG. 2, falls within the range of 0.2 to 3.0 mm, and more particularly preferably falls within the range of 0.5 to 2.0 mm.

Upon usage, this amount of projection (L) makes it possible to apply the paint liquid to most of the hairs only from their roots without delivering the paint liquid to the scalp and others. When the amount of projection is lower than the above range, there is a risk that porous coating body 10 directly comes into contact with the scalp. When it exceeds the above range, it is difficult to supply sufficient paint to the hair roots.

Also, as shown in FIG. 2 porous coating body 10 and comb teeth 14 are preferably arranged closely along side each other so that they are kept out of contact from each other with a spacing S of 5.0 mm or lower, and are particularly preferably arranged apart from each other a distance falling within the range of 0.5 to 3.5 mm. In the present invention, it is not absolutely required that the distance between porous coating body 10 and comb teeth 14 should be kept within a fixed distance or smaller, but specifying the distance within the above range makes it possible to prevent the liquid from dirtying the comber as well as to improve the performance of paint to hair.

Accordingly, comber 30 as the hair coater according to the present invention is constituted of front end 2A of container body 2, porous coating body 10, support member 12 and comb members 11 of base 13 and comb teeth 14.

The aforementioned comber 30 is covered with the aforementioned cap 15. Cap 15 is composed of an inner cap 16, a middle cap 17 and an outer cap 18. Inner cap 16 is formed with an opening portion 22 that abuts the top face of distal end 2B of container body 2. Further, in the front end part of inner cap 16 guide hollows 21 with guide projections for separating comb teeth 14 and porous coating body 10 and for holding the distal ends of these are formed. A coil spring 23 is arranged inside middle cap 17.

In the thus constructed coater-equipped cosmetic container 1, since porous coating body 10 is used in the structure of comber 30, this structure presents more excellent paint performance than that where ejection holes of the paint liquid are formed in the comb teeth themselves. Further, specifying for porous coating body 10 its liquid retention force on the paint liquid being used within the predetermined range makes it possible to sufficiently prevent liquid leakage (forward leakage) of the paint liquid and provide a suitable and uniform supply of the paint liquid to comber 30.

Moreover, rows of comb teeth 14 of comb members 11 are arranged close to the thus formed porous coating body 10, and the distal ends of the comb teeth of the comb members are projected with the predetermined amount, whereby it is possible to prevent the paint liquid from the paint body from being directly delivered to the scalp. Accordingly, there is no risk of dirtying the scalp. Further, specifying the closeness within the predetermined range makes it possible to prevent the paint liquid from dirtying comb members 11 as well as to assure a good combing condition and a sufficient paint performance.

In the above embodiment, distal end 2B of container body 2 is formed as part of comber 30 integrally with container body 2 so that the hair coater according to the present invention is provided as comber 30 of coater-equipped cosmetic container 1. However, the present invention should not be limited to this. The front end part of container body 2 may be formed as a detachable lid member so that the hair coater may be provided as a separate part from the cosmetic container.

Though in the above embodiment, support member 12 of porous coating body 10 and comb members 11 may be detachable from container body 2, they may be configured so as to be fixed to container body 2. In this case, it is preferred that at least one of porous body 10 and comb members 11 is adapted to be detachable. Such a detachable configuration markedly facilitates removal of entangled hairs such as shed hairs sticking to porous coating body 10, and eliminates hindrance to handling performance.

Though in the above embodiment it is specified that comb members 11 are made of resin, other materials than this can be used. For example, metal, natural resin, other natural comb material etc. may be used. However, from an exact sizing viewpoint, resin and metal, which are material having precision formability, are preferable.

In the above embodiment, lid member 5B is removable from reservoir support 4, however lid member 5B may be totally fixed thereto, if required, so as not to be detachable.

In the above embodiment, the paint liquid is a hair dye but should not be limited thereto. Examples may include a hair liquid, a hair tonic, a hair shining agent for pets and other animals, and others. Also, these paint liquids should meet the relationship as to liquid retention force with the aforementioned porous coating body.

FIG. 5 shows another mode of a coater-equipped cosmetic container according to the present invention. Here, for the components of a coater-equipped cosmetic container 40 shown in FIG. 5, identical or similar to those of the cosmetic container shown in FIG. 1, are allotted with the same reference numerals and their detailed description is omitted.

The difference of coater-equipped cosmetic container 40 of this embodiment from container 1 of FIG. 1 is that the porous coating body is made up of a plurality of pen type porous coating elements 41, and these porous coating elements 41 are arranged in a row by a binding member 42 along the adjoining comb teeth. These pen type porous coating elements 41 have a paint liquid retention force falling within the range of 120 to 250 mm, similarly to the embodiment shown in FIG. 1. Further, the distal ends of comb teeth 14 of comb members 13 are arranged so as to stick further out from the distal ends of pen type porous coating elements 41, by 0.2 to 3.0 mm while comb teeth 14 and porous coating elements 41 are kept out of contact with each other with a spacing of 5.0 mm or lower.

Porous coating elements 41 supported by binding member 42 are arranged so as to be apart from each other a distance ranging from 0.4 to 4.0 mm, more preferably, a distance ranging from 0.6 to 2.0 mm. In a distance smaller than the above range, it causes difficulty in combing, and a greater number of shed hairs entangled. On the other hand, a distance greater than the above range makes the contactness between hair and pen type porous coating elements 41 per unit mass worse, resulting in insufficient paint performance.

With the thus constructed coater-equipped cosmetic container 40, it is possible to provide the same effect as that of cosmetic container 1 shown in FIG. 1, it is also possible to achieve fine paint because porous coating elements 41 are comb-shaped.

### INDUSTRIAL USABILITY

With the hair-care coater of the present invention and its coater-equipped cosmetic container, when an paint liquid (hair dye, hair liquid, hair tonic, etc.) stored in a container is applied to hair while coming the hair with the comber provided for the container body, it is possible to provide a suitable supply of the paint liquid without causing any liquid leakage of the paint liquid as well as to secure sufficient paint performance without causing direct contact of the paint liquid with the scalp, hence the invention presents high industrial usability while keeping excellent performance.

1. A hair care coater which, while combing hair by a comber made up of a porous coating body and a comb member arranged parallel to the porous coating body, is able to apply an paint liquid in a container being attached to the hair by means of the porous coating body, wherein the paint liquid retention force of the porous coating body falls within a range of 120 to 250 mm.

2. The hair care coater according to claim 1, wherein the distal ends of comb teeth of the comb member stick further out by a distance ranging from 0.2 to 3.0 mm from the distal end of the porous coating body.

3. The hair coater according to claim 1, wherein the porous coating body and the comb tooth of the comb member are kept out of contact with each other and arranged close to each other with a spacing of 5.0 mm or lower.

4. The hair care coater according to claim 1, wherein the comb tooth of the comb member is formed of resin or metal, and the porous coating body is formed of one or more selected from a sliver pen core, felt-like material or continuous-foamed sponge-like material.

5. The hair care coater according to claim 1, wherein the porous coating body is formed of a plurality of pen type porous coating elements arranged in a comb-like pattern.

6. An coater-equipped cosmetic container comprising: a container body for an paint liquid; and a hair care coater attached to the container body, the hair care coater which, while combing hair by a comber made up of a porous coating body and a comb member arranged parallel to the porous coating body, is able to apply an paint liquid in a container being attached to the hair by means of the porous coating body, wherein the paint liquid retention force of the porous coating body falls within a range of 120 to 250 mm.

7. The coater-equipped cosmetic container according to claim 6, wherein a reservoir support of the paint liquid is accommodated inside the container and the reservoir support comprises padding.

8. The hair coater according to claim 2, wherein the porous coating body and the comb tooth of the comb member are kept out of contact with each other and arranged close to each other with a spacing of 5.0 mm or lower.

9. The hair care coater according to claim 2, wherein the comb tooth of the comb member is formed of resin or metal, and the porous coating body is formed of one or more selected from a sliver pen core, felt-like material or continuous-foamed sponge-like material.

10. The hair care coater according to claim 2, wherein the porous coating body is formed of a plurality of pen type porous coating elements arranged in a comb-like pattern.
